(19) United States
(12) Patent Application Publication
(10) Pub. No.: US 2023/0276395 A1
(43) Pub. Date: Aug. 31, 2023

(54) CONTROL DEVICE, NON-TRANSITORY COMPUTER READABLE MEDIUM, AND COMMUNICATION SYSTEM

(71) Applicant: KABUSHIKI KAISHA TOKAI RIKA DENKI SEISAKUSHO, Aichi (JP)

(72) Inventors: Yuki KONO, Aichi (JP); Shigenori NITTA, Aichi (JP); Masateru FURUTA, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 18/007,512

(22) PCT Filed: Feb. 3, 2021
(86) PCT No.: PCT/JP2021/003860

§ 371 Date: Dec. 1, 2022

(30) Foreign Application Priority Data
Jun. 3, 2020 (JP) 2020-096800

(51) Int. Cl. H04W 64/00; G01S 5/14

(52) U.S. Cl. CPC H04W 64/00; G01S 5/14

(57) ABSTRACT

A control device that communicates with a first communication device and a second communication device includes: a determination section configured to determine a position of a terminal on a basis of a first ranging result obtained from a radio wave communicated between the first communication device and the terminal and a second ranging result obtained from a radio wave communicated between the second communication device and the terminal, wherein the first communication device is disposed at a first position where it is difficult to directly receive the radio wave between a first area and a second area that are separated by a first member including material through which it is difficult for the radio wave to penetrate, and the second communication device is disposed at a second position where it is possible to directly receive the radio wave between the first area and the second area.

### TECHNICAL FIELD

The present invention relates to a control device, a program, and a communication system.

### BACKGROUND ART

In recent years, technologies of detecting a position of a terminal used by a user have been known. For example, a technology of detecting a position of a terminal on the basis of propagation time of a radio wave transmitted/received between a communication device installed in a vehicle and a terminal used by a user has been known (for example, see Patent Literature 1). Such a technology permits action of the vehicle in the case where the detected position of the terminal satisfies a condition.

### CITATION LIST

### Patent Literature

Patent Literature 1: U.S. Pat. No. 9,566,945 B

### Disclosure of Invention

### Technical Problem

However, the general technologies of detecting the position of a terminal have a problem that accuracy of detecting the position of the terminal is not improved.

Accordingly, the present invention is made in view of the aforementioned problem, and an object of the present invention is to provide a novel and improved technology that makes it possible to improve accuracy of detecting a position of a terminal.

### Solution to Problem

To solve the above described problem, according to an aspect of the present invention, there is provided a control device that communicates with a first communication device and a second communication device, the control device comprising: a determination section configured to determine a position of a terminal on a basis of a first ranging result obtained from a radio wave communicated between the first communication device and the terminal and a second ranging result obtained from a radio wave communicated between the second communication device and the terminal, wherein the first communication device is disposed at a first position where it is difficult to directly receive the radio wave between a first area and a second area that are separated by a first member including material through which it is difficult for the radio wave to penetrate, and the second communication device is disposed at a second position where it is possible to directly receive the radio wave between the first area and the second area.

To solve the above described problem, according to another aspect of the present invention, there is provided a program that causes a computer to function as a control device configured to communicate with a first communication device and a second communication device, the control device including: a determination section configured to determine a position of a terminal on a basis of a first ranging result obtained from a radio wave communicated between the first communication device and the terminal and a second ranging result obtained from a radio wave communicated between the second communication device and the terminal, wherein the first communication device is disposed at a first position where it is difficult to directly receive the radio wave between a first area and a second area that are separated by a first member including material through which it is difficult for the radio wave to penetrate, and the second communication device is disposed at a second position where it is possible to directly receive the radio wave between the first area and the second area.

To solve the above described problem, according to another aspect of the present invention, there is provided a communication system comprising: a first communication device configured to be disposed at a first position where it is difficult to directly receive a radio wave between a first area and a second area that are separated by a first member including material through which it is difficult for the radio wave to penetrate, a second communication device configured to be disposed at a second position where it is possible to directly receive a radio wave between the first area and the second area, and a control device including a determination section configured to determine a position of a terminal on a basis of a first ranging result obtained from a radio wave communicated between the first communication device and the terminal and a second ranging result obtained from a radio wave communicated between the second communication device and the terminal.

### Advantageous Effects of Invention

As described above, according to the present invention, it is possible to provide the technology that makes it possible to improve accuracy of detecting the position of a terminal.

### BRIEF DESCRIPTION OF DRAWINGS

FIG. 1 is a diagram illustrating a vehicle in which two communication devices are disposed on its ceiling of a vehicle cabin when viewed from above.

FIG. 2 is a diagram illustrating the vehicle in which the two communication devices are disposed on its ceiling of the vehicle cabin when viewed from behind.

FIG. 3 is a diagram for describing an overview of a communication system according to an embodiment of the present invention.

FIG. 4 is a diagram for describing a specific example of disposing the two communication devices.

FIG. 5 is a diagram for describing the specific example of disposing the two communication devices.

FIG. 6 is a diagram for describing the specific example of disposing the two communication devices.

FIG. 7 is a diagram illustrating a configuration example of the communication system according to the embodiment of the present invention.

FIG. 8 is a flowchart illustrating a behavior example of the communication system according to the embodiment of the present invention.

FIG. 9 is a flowchart illustrating a behavior example of the communication system according to the embodiment of the present invention.

### MODE(S) FOR CARRYING OUT THE INVENTION

Hereinafter, referring to the appended drawings, preferable embodiments of the present invention will be described in detail. Note that, in this specification and the appended drawings, structural elements that have substantially the same function and structure are denoted with the same reference signs, and repeated explanation of these structural elements will be omitted.

### 0. Background

First, a background of embodiments of the present invention will be described. In recent years, technologies of detecting a position of a terminal used by a user have been known. For example, technologies of detecting a position of a terminal on the basis of propagation time of a radio wave transmitted/received between a communication device installed in a vehicle and a terminal used by a user have been known. For example, technologies of detecting a position of a terminal on the basis of propagation time of a radio wave transmitted/received between a terminal used by a user and each of two communication devices installed in a vehicle have been known.

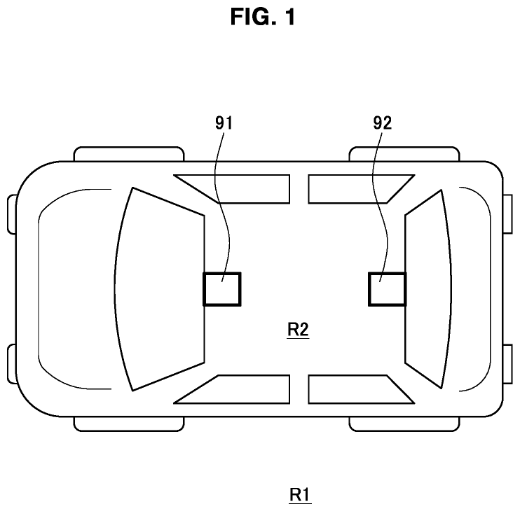

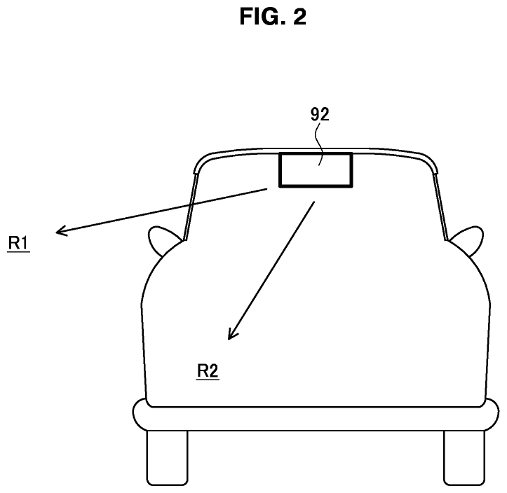

Two communication devices may be installed in an inside of a vehicle in the case where the two devices are disposed in the vehicle. Such a general technology will be described with reference to FIG. 1 and FIG. 2. Specifically, FIG. 1 and FIG. 2 illustrate an example of determining whether positions of terminals are within or outside a vehicle (vehicle cabin).

FIG. 1 is a diagram illustrating the vehicle in which two communication devices are disposed on its ceiling of the vehicle cabin. In addition, FIG. 2 is a diagram illustrating the vehicle in which the two communication devices are disposed on its ceiling of the vehicle cabin when viewed from behind. FIG. 1 and FIG. 2 illustrate a communication device 91 as a first communication device. In addition, FIG. 1 1 illustrates a communication device 92 as a second communication device. The communication device 91 and the communication device 92 are disposed on the ceiling of the vehicle. In addition, in FIG. 1 and FIG. 2, an outside R1 of the vehicle cabin indicates an outside of the vehicle, and an inside R2 of the vehicle cabin indicates an inside of the vehicle.

Here, as recognized from FIG. 2, the ceiling on which the communication device 91 and the communication device 92 are disposed in the vehicle cabin may corresponds to a position shielded from the outside R1 of the vehicle cabin by glass window parts. In this case, the glass window parts of the vehicle are made of material that allows radio waves to penetrate through easily. Therefore, the communication device 91 and the communication device 92 that are disposed on the ceiling in the vehicle cabin are capable of directly receiving the radio waves communicated between the outside R1 of the vehicle cabin and the inside R2 of the vehicle cabin via the glass window parts of the vehicle.

Due to such a circumstance, sometimes a distance measured based on propagation time of a radio wave transmitted/received between the communication device 91 and a terminal present in the outside R1 of the vehicle cabin may be equal to a distance measured based on propagation time of a radio wave transmitted/received between the communication device 91 and a terminal present in the inside R2 of the vehicle cabin. The same applies to distances measured based on propagation time of radio waves transmitted/received between the terminals and the communication device 92. In other words, it is difficult to determine with high accuracy whether the position of the terminal is the outside R1 of the vehicle cabin or the inside R2 of the vehicle cabin, in the case where both the communication device 91 and the communication device 92 are disposed on the ceiling in the inside R2 of the vehicle cabin.

Therefore, it also can be assumed that a third communication device is disposed in the inside R2 of the vehicle cabin to determine whether the position of the terminal is the outside R1 of the vehicle cabin or the inside R2 of the vehicle cabin on the basis of propagation time of respective radio waves transmitted/received between the terminal and the three communication devices. This makes it possible to determine with higher accuracy whether the position of the terminal is the outside R1 of the vehicle cabin or the inside R2 of the vehicle cabin, in comparison with the case where the two communication devices are disposed in the inside R2 of the vehicle cabin. However, the installation of the third communication device requires an extra cost.

Accordingly, embodiments of the present invention mainly propose a technology capable of improving accuracy of detecting the position of a terminal while reducing cost.

### 1. Embodiment

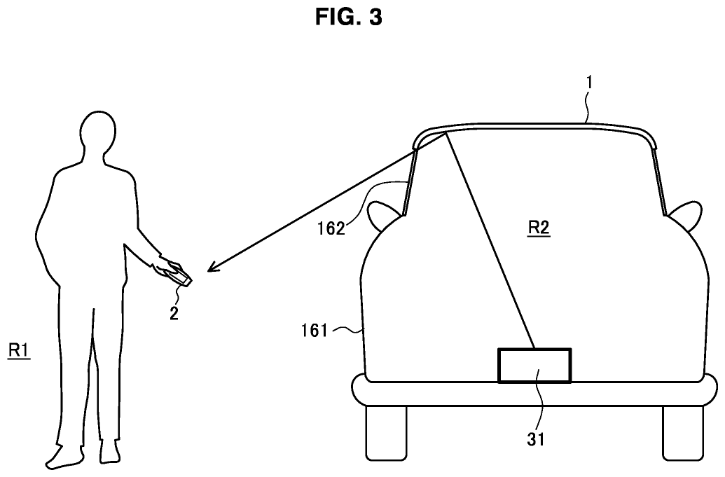

Next, a communication system according to an embodiment of the present invention will be described. First, an overview of the communication system according to the embodiment of the present invention will be described with reference to FIG. 3.

### 1.1. Overview

FIG. 3 is a diagram for describing an overview of the communication system according to the embodiment of the present invention. FIG. 3 illustrates a terminal 2 used by a user. The terminal 2 is held by the user. The user (and the terminal 2) is present in the outside R1 of the vehicle cabin. In addition, FIG. 3 also illustrates a vehicle 1 and the inside R2 of the vehicle cabin. The outside R1 of the vehicle cabin is separated from the inside R2 of the vehicle cabin by a glass window part 162. The outside R1 of the vehicle cabin is separated from the inside R2 of the vehicle cabin also by a part of a side surface of the vehicle 1, the part being below the glass window parts 162 (hereinafter, the part is also referred to as a “frame part 161”).

The frame part 161 corresponds to an example of a member (first member) including material through which it is difficult for radio waves to penetrate. Therefore, the frame part 161 may be replaced with other parts including material through which it is difficult for radio waves to penetrate. In addition, examples of the material through which it is difficult for radio waves to penetrate typically include metal. However, the material through which it is difficult for radio waves to penetrate may be replaced with material other than the metal. The material included in the frame part 161 is material through which it is relatively more difficult for radio waves to penetrate than the material included in the glass window parts 162.

The glass window parts 162 correspond to an example of a member (second member) including material that allows radio waves to penetrate easily. Therefore, the glass window parts 162 may be replaced with other parts including material that allows radio waves to penetrate through easily. For example, the glass window parts 162 may be open, or does not have to be installed in the vehicle 1 in the first place (in other words, the glass window parts 162 may be replaced with air). In addition, examples of the material that allows radio waves to penetrate through easily typically include glass. However, the material that allows radio waves to penetrate through easily may be replaced with material other than the glass. The material included in the glass window parts 162 is material that allows radio waves to penetrate through relatively more easily than the material included in the frame part 161.

Note that, the outside R1 of the vehicle cabin corresponds to an example of a first area, and the inside R2 of the vehicle cabin corresponds to an example of a second area. In other words, the outside R1 of the vehicle cabin and the inside R2 of the vehicle cabin respectively correspond to the first area and the second area that are separated by the member including material through which it is difficult for the radio wave to penetrate and the material that allows the radio waves to penetrate through easily. Therefore, the outside R1 of the vehicle cabin and the inside R2 of the vehicle cabin may be replaced with other areas that are separated by a member including material through which it is difficult for the radio wave to penetrate and a member including material that allows the radio waves to penetrate through easily.

As illustrated in FIG. 3, according to the embodiment of the present invention, at least one communication device 31 is disposed at a position (first position) where it is difficult to directly receive the radio waves communicated between the outside R1 of the vehicle cabin and the inside R2 of the vehicle cabin. More specifically, the position where it is difficult to directly receive the radio waves communicated between the outside R1 of the vehicle cabin and the inside R2 of the vehicle cabin is a position in the inside R2 of the vehicle cabin, the position being shielded from the outside R1 of the vehicle cabin (in particular, a low-positioned area where the terminal 2 is present in the outside R1 of the vehicle cabin) by the frame part 161. Here, as illustrated in FIG. 3, typically, a bottom surface in the inside R2 of the vehicle cabin may be the position in the inside R2 of the vehicle cabin, the position being shielded from the outside R1 of the vehicle cabin by the frame part 161. However, the position shielded from the outside R1 of the vehicle cabin by the frame part 161 is not limited to the bottom surface in the inside R2 of the vehicle cabin.

According to the embodiment of the present invention, the at least one communication device 31 is disposed at the position where it is difficult to directly receive the radio waves communicated between the outside R1 of the vehicle cabin and the inside R2 of the vehicle cabin, as described above. Therefore, a large ranging value is obtained on the basis of propagation time of a radio wave communicated between the communication device 31 and the terminal 2 present in the outside R1 of the vehicle cabin. This makes it possible to reduce a possibility that a ranging value based on propagation time of a radio wave transmitted/received between the communication device 31 and the terminal 2 present in the outside R1 of the vehicle cabin is equal to a ranging value based on propagation time of a radio wave transmitted/received between the communication device 31 and the terminal 2 present in the inside R2 of the vehicle cabin. Therefore, according to the embodiment of the present invention, it is possible to determine the position of the terminal 2 with high accuracy.

Note that, the following description mainly focuses on a case of determining whether the position of the terminal 2 is in the outside R1 of the vehicle cabin or the inside R2 of the vehicle cabin. However, as will be described later, embodiments of the present invention are not limited to the case of determining whether the position of the terminal 2 is in the outside R1 of the vehicle cabin or the inside R2 of the vehicle cabin, but the present invention is applicable to a variety of cases such as a case of determining whether the position of the terminal 2 is within a third area or a fourth area.

In addition, in view of more accurate calculation of ranging values between a terminal and communication devices, the following description mainly focuses on a case of calculating the ranging values on the basis of propagation time of radio waves communicated between the terminal and the communication devices. However, it is also possible to calculate the ranging values on the basis of values other than the propagation time of the radio waves. For example, the ranging value may be calculated on the basis of a received signal strength indicator (RSSI) of a radio wave that is transmitted from one of the terminal and the communication device and received by the other of the terminal and the communication device. In other words, in the following description, the ranging value based on the propagation time of the radio wave may be replaced with the ranging value based on the radio wave.

### Specific Example of Disposing Communication Devices

Next, a specific example of disposing the communication devices will be described in detail.

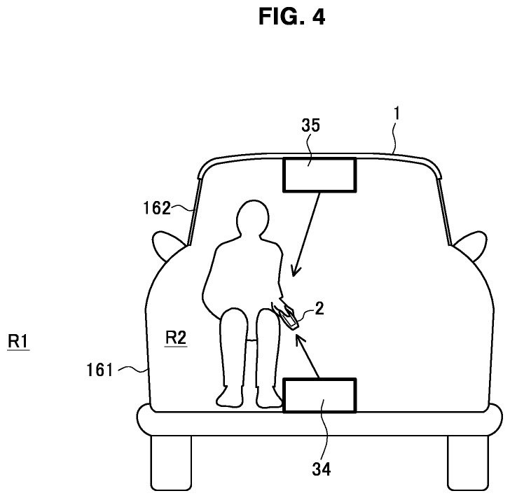

FIG. 4 to FIG. 6 are diagrams for describing the specific example of disposing two communication devices. As illustrated in FIG. 4 to FIG. 4, according to the embodiment of the present invention, a first communication device 34 (corresponding to an example of the communication device 31) is disposed at a position (a bottom surface in the inside R2 of the vehicle cabin with reference to the example illustrated in FIG. 4 to FIG. 6) where it is difficult to directly receive the radio waves communicated between the outside R1 of the vehicle cabin and the inside R2 of the vehicle cabin (through the frame part 161). In addition, according to the embodiment of the present invention, a second communication device 35 is also disposed at a position (second position) where it is possible to directly receive the radio waves communicated between the outside R1 of the vehicle cabin and the inside R2 of the vehicle cabin (through the glass window part 162).

More specifically, the position where it is possible to directly receive the radio waves communicated between the outside R1 of the vehicle cabin and the inside R2 of the vehicle cabin may be a position in the inside R2 of the vehicle cabin, and the position is not shielded from the outside R1 of the vehicle cabin (in particular, a low-positioned area where the terminal 2 may be present in the outside R1 of the vehicle cabin) by the frame part 161.

For example, as illustrated in FIG. 4 to FIG. 6, the position where it is possible to directly receive the radio waves communicated between the outside R1 of the vehicle cabin and the inside R2 of the vehicle cabin is a position in the inside R2 of the vehicle cabin, the position being shielded from the outside R1 of the vehicle cabin (in particular, a low-positioned area where the terminal 2 may be present in the outside R1 of the vehicle cabin) by the glass window part 162. Here, as illustrated in FIG. 4 to FIG. 6, typically, the ceiling in the inside R2 of the vehicle cabin may be the position in the inside R2 of the vehicle cabin, the position being shielded from the outside R1 of the vehicle cabin by the glass window part 162. However, the position shielded from the outside R1 of the vehicle cabin by the glass window part 162 is not limited to the ceiling in the inside R2 of the vehicle cabin.

In particular, in the example illustrated in FIG. 4, the terminal 2 is present in the inside R2 of the vehicle cabin. In this case, both the ranging value based on the propagation time of the radio wave communicated between the first communication device 34 and the terminal 2 and the ranging value based on the propagation time of the radio wave communicated between the second communication device 35 and the terminal 2 are small. Therefore, it is possible to determine that the position of the terminal 2 is the inside R2 of the vehicle cabin when a condition that the ranging value based on the propagation time of the radio wave communicated between the first communication device 34 and the terminal 2 is smaller than a first threshold and a condition that the ranging value based on the propagation time of the radio wave communicated between the second communication device 35 and the terminal 2 is smaller than a second threshold are satisfied. Note that, it is assumed that the first threshold is typically equal to the second threshold, but the first threshold does not have to be equal to the second threshold.

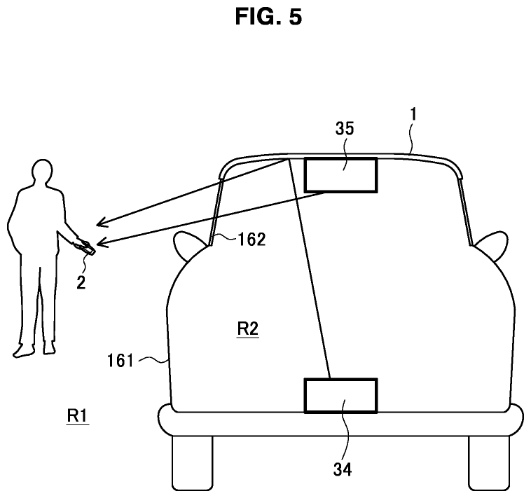

On the other hand, in the example illustrated in FIG. 5, the terminal 2 is present in the outside R1 of the vehicle cabin but the terminal 2 is relatively close to the vehicle 1. In this case, the ranging value based on the propagation time of the radio wave communicated between the second communication device 35 and the terminal 2 is small, but the ranging value based on the propagation time of the radio wave communicated between the first communication device 34 and the terminal 2 is large (or a ranging result indicates that communication is not available). Therefore, it is possible to determine that the position of the terminal 2 is the outside R1 of the vehicle cabin when the condition that the ranging value based on the propagation time of the radio wave communicated between the first communication device 34 and the terminal 2 is smaller than the first threshold (or the condition that the ranging value based on the propagation time of the radio wave communicated between the second communication device 35 and the terminal 2 is smaller than the second threshold) is not satisfied.

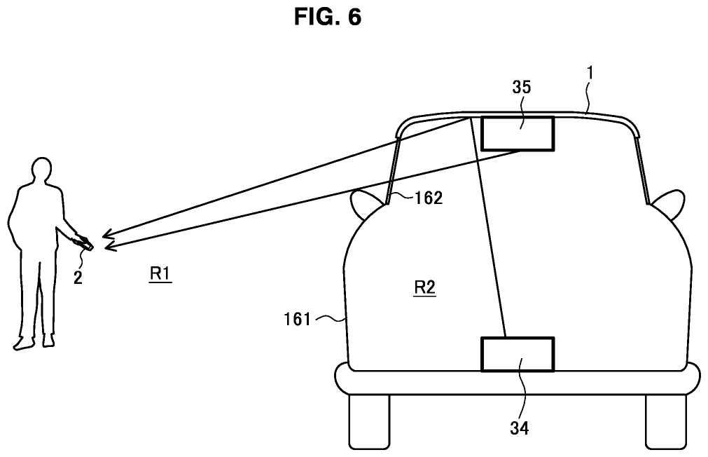

Alternatively, in the example illustrated in FIG. 6, the terminal 2 is present in the outside R1 of the vehicle cabin and the terminal 2 is relatively far from the vehicle 1. In this case, both the ranging value based on the radio wave communicated between the first communication device 34 and the terminal 2 and the ranging value based on the radio wave communicated between the second communication device 35 and the terminal 2 are large (or a ranging result indicates that communication is not available). Therefore, it is possible to determine that the position of the terminal 2 is the outside R1 of the vehicle cabin when both the condition that the ranging value based on the radio wave communicated between the first communication device 34 and the terminal 2 is greater than or equal to the first threshold and the condition that the ranging value based on the radio wave communicated between the second communication device 35 and the terminal 2 is greater than or equal to the second threshold are satisfied.

### 1.3. Configuration Example

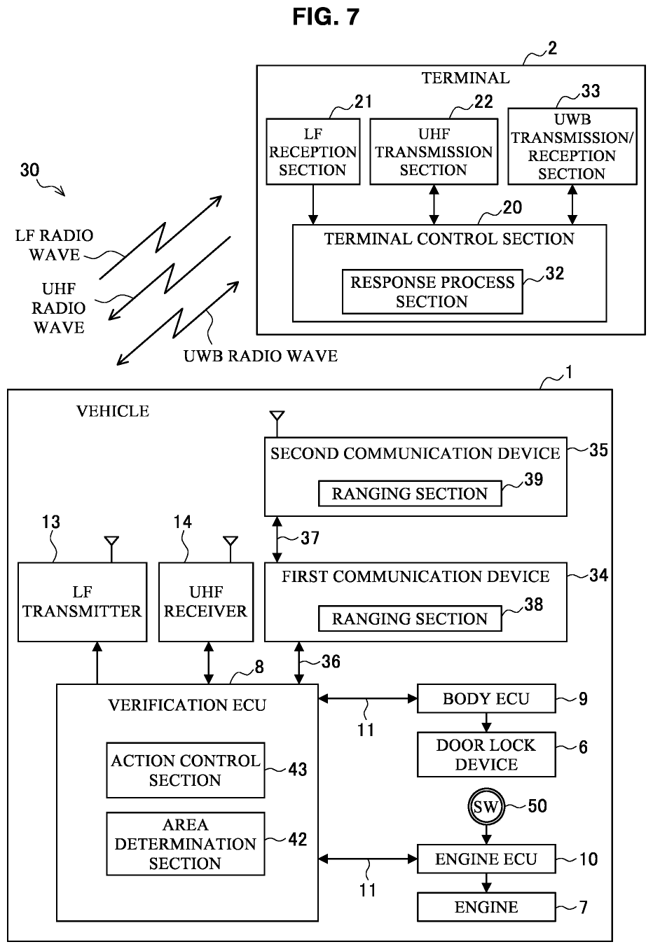

Next, a configuration example of the communication system according to the embodiment of the present invention will be described with reference to FIG. 7.

FIG. 7 is a diagram illustrating the configuration example of the communication system according to the embodiment of the present invention. As illustrated in FIG. 7, the communication system 1 according to the present embodiment includes the vehicle 1 and the terminal 2. Note that, the embodiment of the present embodiment mainly assumes a case where the terminal 2 is an electronic key. However, the terminal 2 is not limited to the electronic key. For example, the terminal 2 may be a terminal other than the electronic key such as a smartphone, a tablet terminal, a mobile phone, or another electronic device.

### Configuration of Vehicle

Next, a configuration of the vehicle 1 will be described. As illustrated in FIG. 7, the vehicle 1 includes a door lock device 6 serving as an example of an in-vehicle device, an engine 7 serving as an example of the in-vehicle device, a verification electronic control unit (ECU) 8, a body ECU 9, an engine ECU 10, a low frequency (LF) transmitter 13, an ultra high frequency (UHF) receiver 14, the first communication device 34, and the second communication device 35.

The door lock device 6 controls locking/unlocking of vehicle doors. The engine 7 is an engine of the vehicle 1. Details of the first communication device 34 and the second communication device 35 will be described later. The verification ECU 8 includes an area determination section 42 and an action control section 43. Details of the area determination section 42 and the action control section 43 will be described later. The body ECU 9 manages a power supply of in-vehicle electric equipment. For example, the body ECU 9 controls the door lock device 6 that switches between a locked state and an unlocked state of the vehicle doors. The engine ECU 10 controls the engine 7.

The verification ECU 8, the body ECU 9, and the engine ECU 10 are connected via communication lines 11 in the vehicle 1. These ECUs may perform respective functions by executing corresponding programs. In particular, the verification ECU 8 may execute the program to cause a computer to function as the control device including the area determination section 42 and the action control section 43. For example, a protocol used for communication via the communication lines 11 may be a Controller Area Network (CAN) or a Local Interconnect Network (LIN).

The LF transmitter 13 transmits an LF radio wave to the terminal 2. In addition, when the terminal 2 receives the LF radio wave and transmits an UHF radio wave, the UHF receiver 14 receives the UHF radio wave transmitted from the terminal 2.

### Configuration of Terminal

Next, a configuration of the terminal 2 will be described. The terminal 2 includes a terminal control section 20, an LF reception section 21, an UHF transmission section 22, and an ultra-wideband (UWB) transmission/reception section 33. The terminal control section 20 controls the terminal 2. The terminal control section 20 includes a response process section 32. Details of the response process section 32 will be described later.

The LF reception section 21 receives an LF radio wave transmitted from the vehicle 1. When the LF reception section 21 receives the LF radio wave transmitted from the vehicle 1, the UHF transmission section 22 transmits an UHF radio wave to the vehicle 1. Details of the UWB transmission/reception section 33 will be described later.

### Distance Measurement System

As illustrated in FIG. 7, the communication system according to the embodiment of the present invention includes a distance measurement system 30. Next, the distance measurement system 30 will be described. The distance measurement system mainly includes the UWB transmission/reception section 33 and the response process section 32 of the terminal 2, and the first communication device 34, the second communication device 35, the area determination section 42, and the action control section 43 of the vehicle 1.

The UWB transmission/reception section 33 performs communication (hereinafter, also referred to as “ranging communication”) with the first communication device 34 and the second communication device 35 to obtain respective ranging values. In addition, the first communication device 34 performs the ranging communication with the terminal 2. In a similar way, the second communication device 35 performs the ranging communication with the terminal 2.

The first communication device 34 is connected to the verification ECU 8 via a communication line 36. The first communication device 34 includes a ranging section 38. Details of the ranging section 38 will be described later. In addition, the second communication device 35 is connected to the first communication device 34 via a communication line 37. The second communication device 35 includes a ranging section 39. Details of the ranging section 39 will be described later.

For example, the LIN or CAN may be used as a communication protocol for the communication via the communication line 36 and the communication line 37. Note that, a communication interface such as a universal asynchronous receiver-transmitter (UART) may be used for the communication line 36. In addition, the second communication device 35 may be connected to the verification ECU 8 via a communication line (in other words, the second communication device 35 may be directly connected to the verification ECU 8 without the first communication device 34). That is, the second communication device 35 is capable of (directly) communicating with the verification ECU 8 (without the first communication device 34).

First, the LF transmitter 13 of the vehicle 1 transmits an wake signal periodically or randomly on a low frequency (LF). When the LF reception section 21 receives the wake signal, the terminal control section 20 of the terminal 2 shifts from a standby state to an activated state, and the UHF transmission section 22 transmits an ACK signal on an ultra high frequency (UHF). When the UHF receiver 14 receives the ACK signal transmitted from the terminal 2 in response to the wake signal, the area determination section 42 of the vehicle 1 outputs a ranging communication start request (hereinafter, also referred to as a “ranging request”) to the first communication device 34 and the second communication device 35.

### Ranging Communication

Next, the ranging communication will be described. For example, when the verification ECU 8 outputs the ranging request, the first communication device 34 accepts input of the ranging request from the verification ECU 8. When the first communication device 34 accepts the input of the ranging request, the first communication device 34 outputs the ranging request to the second communication device 35. When the first communication device 34 outputs the ranging request, the second communication device 35 accepts input of the ranging request from the first communication device 34.

When the first communication device 34 accepts the input of the ranging request, the first communication device 34 starts the ranging communication with the terminal 2. Note that, the embodiment of the present invention mainly assumes that UWB radio waves are used as radio waves for the ranging communication (ranging radio wave and response radio wave). Therefore, hereinafter, sometimes the radio wave for the ranging communication may also be referred to as a “UWB radio wave”. However, the radio wave for the ranging communication is not limited to the UWB radio wave.

First, in the ranging communication, the first communication device 34 transmits a UWB radio wave. When the UWB radio wave is received from the ranging section 38 of the first communication device 34 via the UWB transmission/reception section 33, the response process section 32 of the terminal 2 returns a UWB radio wave as a response via the UWB transmission/reception section 33. Next, the first communication device 34 receives the UWB radio wave transmitted from the terminal 2. At this time, the ranging section 38 of the first communication device 34 calculates a ranging value on the basis of propagation time of the UWB radio waves communicated between the first communication device 34 and the terminal 2.

More specifically, the ranging section 38 of the first communication device 34 calculates the propagation time from the transmission of a UWB radio wave to the reception of a UWB radio wave serving as a response by using a time-of-flight (TOF) method, and obtains a ranging result (first ranging result) of a distance between the first communication device 34 and the terminal 2 on the basis of the propagation time. In a similar way, the ranging section 39 of the second communication device 35 obtains a ranging result (second ranging result) of a distance between the second communication device 35 and the terminal 2 when the input of the ranging request is accepted.

Note that, the embodiment of the present invention mainly assumes the case where the first communication device 34 and the second communication device 35 calculate the propagation times and the ranging values. However, it is also possible for the terminal 2 to calculate the propagation times and the ranging values. In this case, the terminal 2 may transmit respective UWB radio waves to the first communication device 34 and the second communication device 35, and the first communication device 34 and the second communication device 35 return respective UWB radio waves to the terminal 2 as responses.

In addition, each of the first communication device 34 and the second communication device 35 may perform ranging one time. In such a case, respective ranging results obtained by the first communication device 34 and the second communication device 35 may be output to the verification ECU 8 without any change. However, it is also considered that the ranging results obtained by the first communication device 34 and the second communication device 35 may include a less-accurate ranging result.

Accordingly, the first communication device 34 may perform the ranging multiple times and output a ranging result (hereinafter, also referred to as “Amin”) indicating a minimum ranging value among the plurality of ranging results, to the verification ECU 8. In a similar way, the second communication device 35 may perform the ranging multiple times and output a ranging result (hereinafter, also referred to as “Bmin”) indicating a minimum ranging value among the plurality of ranging results, to the verification ECU 8. This makes it possible to obtain a more accurate ranging result.

Hereinafter, n number of times represents the number of times of ranging performed by each of the first communication device 34 and the second communication device 35(n is an integer greater than or equal to 1).

Note that, the first communication device 34 may detect a ranging result Amin indicating a minimum ranging value among a plurality of ranging results A1 to An, and may output the ranging result Amin alone to the verification ECU 8. Alternatively, the first communication device 34 may output the plurality of ranging results A1 to An to the verification ECU 8, and the verification ECU 8 may detect the ranging result Amin indicating the minimum ranging value among the plurality of ranging results A1 to An.

In a similar way, the second communication device 35 may detect a ranging result Bmin indicating a minimum ranging value among a plurality of ranging results B1 to Bn, and may output the ranging result Bmin alone to the verification ECU 8. Alternatively, the second communication device 35 may output the plurality of ranging results B1 to Bn to the verification ECU 8, and the verification ECU 8 may detect the ranging result Bmin indicating the minimum ranging value among the plurality of ranging results B1 to Bn.

### Determination of Ranging Result

The verification ECU 8 accepts input of a ranging result of a distance between the first communication device 34 and the terminal 2 and accepts input of a ranging result of a distance between the second communication device 35 and the terminal 2. The area determination section 42 of the verification ECU 8 determines the position of the terminal 2 on the basis of the ranging result of the distance between the first communication device 34 and the terminal 2 and the ranging result of the distance between the second communication device 35 and the terminal 2. This makes it possible to improve accuracy of detecting the position of the terminal 2.

More specifically, the area determination section 42 determines whether the position of the terminal 2 is the outside R1 of the vehicle cabin (an example of the inside of the third area) or the inside R2 of the vehicle cabin (an example of the inside of the fourth area) on the basis of the ranging result of the distance between the first communication device 34 and the terminal 2 and the ranging result of the distance between the second communication device 35 and the terminal 2. This makes it possible to determine with higher accuracy whether the terminal 2 is present in the outside R1 of the vehicle cabin or the inside R2 of the vehicle cabin.

For example, the area determination section 42 determines whether the position of the terminal 2 is the inside R2 of the vehicle cabin or the outside R1 of the vehicle cabin on the basis of whether a condition that a ranging value indicated by the ranging result Amin of a distance between the first communication device 34 and the terminal 2 is smaller than the first threshold and a condition that a ranging value indicated by the ranging result Bmin of a distance between the second communication device 35 and the terminal 2 is smaller than the second threshold are satisfied.

This makes it possible to detect with higher accuracy whether the terminal 2 is present in the outside R1 of the vehicle cabin or the inside R2 of the vehicle cabin when the first threshold and the second threshold are properly set. Note that, as described above it is assumed that the first threshold is typically equal to the second threshold, but the first threshold does not have to be equal to the second threshold.

For example, the area determination section 42 determines that the position of the terminal 2 is the inside R2 of the vehicle cabin in the case where the condition that the ranging value indicated by the ranging result Amin of the distance between the first communication device 34 and the terminal 2 is smaller than the first threshold and the condition that the ranging value indicated by the ranging result Bmin of the distance between the second communication device 35 and the terminal 2 is smaller than the second threshold are satisfied (see FIG. 4).

Alternatively, the area determination section 42 determines that the position of the terminal 2 is the outside R2 of the vehicle cabin in the case where at least any one of the condition that the ranging value indicated by the ranging result Amin of the distance between the first communication device 34 and the terminal 2 is smaller than the first threshold and the condition that the ranging value indicated by the ranging result Bmin of the distance between the second communication device 35 and the terminal 2 is smaller than the second threshold is not satisfied (see FIG. 5 and FIG. 6).

### Action Based on Ranging Result

The action control section 43 of the verification ECU 8 controls action of the vehicle 1 (serving as an example of the mobile object) on the basis of the position of the terminal 2 determined by the area determination section 42. This makes it possible to control the action of the vehicle 1 on the basis of the terminal 2 and to improve convenience for the users. Note that, the target whose action is controlled by the action control section 43 is not limited to the vehicle 1. The action control section 43 may control action of a machine or device other than the vehicle 1 on the basis of the position of the terminal 2 determined by the area determination section 42.

For example, the action control section 43 may permit doors of the vehicle 1 to be locked or unlocked in the case where the area determination section 42 has determined that the position of the terminal 2 is the outside R1 of the vehicle cabin (an example of the inside of the third area). More specifically, the action control section 43 may permit the body ECU 9 to lock or unlock the door lock device 6 in the case where the area determination section 42 has determined that the position of the terminal 2 is the outside R1 of the vehicle cabin. Therefore, for example, a vehicle door is unlocked when a vehicle exterior door handle is touched in a state where the door is locked. In addition, the vehicle door is locked when a lock button of the vehicle exterior door handle is pushed in a state where the door is unlocked.

For another example, the action control section 43 may permit the engine of the vehicle 1 to start in the case where the area determination section 42 has determined that the position of the terminal 2 is the inside R2 of the vehicle cabin (an example of the inside of the fourth area). More specifically, the action control section 43 may permit a transition operation of a vehicle power supply via an ignition switch 50 in the vehicle cabin in the case where the area determination section 42 has determined that the position of the terminal 2 is the inside R2 of the vehicle cabin. Therefore, for example, the engine 7 starts when the ignition switch 50 is operated while a brake pedal is depressed.

### 1.4. Behavior Example

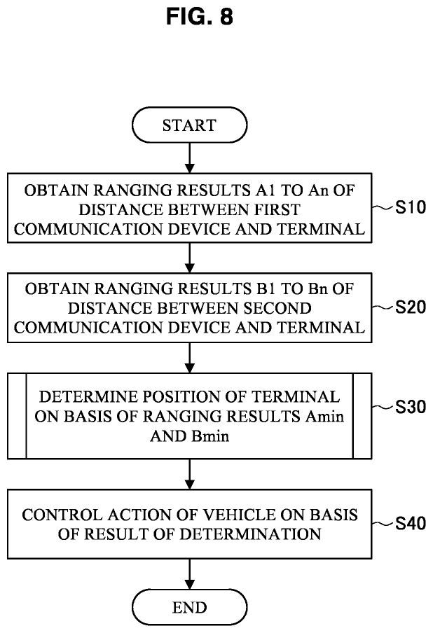

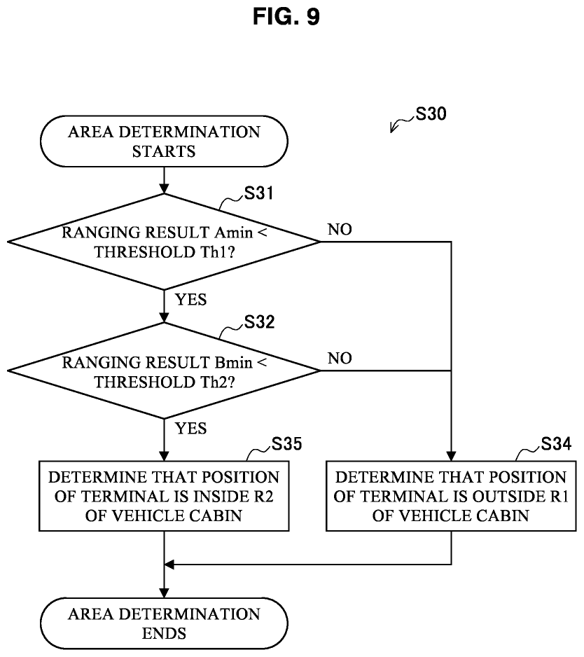

Next, behavior examples of the communication system according to the embodiment of the present invention will be described with reference to FIG. 8 and FIG. 9.

FIG. 8 and FIG. 9 are flowcharts illustrating the behavior examples of the communication system according to the embodiment of the present invention. First, the LF transmitter 13 of the vehicle 1 transmits an wake signal on a low frequency (LF). When the LF reception section 21 of the terminal 2 receives the wake signal, the terminal control section 20 shifts the terminal 2 from the standby state to the activated state, and the UHF transmission section 22 transmits an ACK signal on an ultra high frequency (UHF). When the UHF receiver 14 of the vehicle 1 receives the ACK signal transmitted from the terminal 2 in response to the wake signal, a ranging request is output to the first communication device 34 and the second communication device 35.

When the verification ECU 8 outputs the ranging request, the first communication device 34 accepts input of the ranging request from the verification ECU 8. When the first communication device 34 accepts the input of the ranging request, the first communication device 34 outputs the ranging request to the second communication device 35. When the first communication device 34 outputs the ranging request, the second communication device 35 accepts input of the ranging request from the first communication device 34.

As illustrated in FIG. 8, when the first communication device 34 accepts the input of the ranging request, the ranging section 38 of the first communication device 34 calculates propagation time from transmission of a UWB radio wave to reception of a UWB radio wave serving as a response, and obtains ranging results of a distance between the first communication device 34 and the terminal 2 (ranging results A1 to An obtained through n number of times of ranging) on the basis of the propagation time (Step S10). In a similar way, when the second communication device 35 accepts the input of the ranging request, the ranging section 39 of the second communication device 35 obtains ranging results of a distance between the second communication device 35 and the terminal 2 (ranging results B1 to Bn obtained through n number of times of ranging) (Step S10).

The first communication device 34 outputs a ranging result Amin indicating a minimum ranging value among the plurality of ranging results A1 to An, to the verification ECU 8. In a similar way, the second communication device 35 outputs a ranging result Bmin indicating a minimum ranging value among the plurality of ranging results B1 to Bn, to the verification ECU 8. The verification ECU 8 accepts input of the ranging result Amin of the distance between the first communication device 34 and the terminal 2 and accepts input of the ranging result Bmin of the distance between the second communication device 35 and the terminal 2.

Next, the area determination section 42 determines the position of the terminal 2 on the basis of the ranging result Amin of the distance between the first communication device 34 and the terminal 2 and the ranging result Bmin of the distance between the second communication device 35 and the terminal 2 (Step S30). Next, details of Step S30 will be described with reference to FIG. 9.

As illustrated in FIG. 9, the area determination section 42 proceeds to Step S32 in the case where a condition that the ranging value indicated by the ranging result Amin of the distance between the first communication device 34 and the terminal 2 is smaller than the first threshold Th1 is satisfied (YES in Step S31). On the other hand, the area determination section 42 proceeds to Step S34 in the case where the condition that the ranging value indicated by the ranging result Amin of the distance between the first communication device 34 and the terminal 2 is smaller than the first threshold Th1 is not satisfied (NO in Step S31).

Next, the area determination section 42 proceeds to Step S35 in the case where a condition that the ranging value indicated by the ranging result Bmin of the distance between the second communication device 35 and the terminal 2 is smaller than the second threshold Th2 is satisfied (YES in Step S32). On the other hand, the area determination section 42 proceeds to Step S34 in the case where the condition that the ranging value indicated by the ranging result Bmin of the distance between the second communication device 35 and the terminal 2 is smaller than the second threshold Th2 is not satisfied (NO in Step S32).

In the case where the area determination section 42 proceeds to Step S34, the area determination section 42 determines that the position of the terminal 2 is the outside R1 of the vehicle cabin (an example of the inside of the third area) (Step S34). On the other hand, in the case where the area determination section 42 proceeds to Step S35, the area determination section 42 determines that the position of the terminal 2 is the inside R2 of the vehicle cabin (an example of the inside of the forth area) (Step S35).

Referring again to FIG. 8, the action control section 43 controls action of the vehicle 1 on the basis of a result of the determination made by the area determination section 42 (Step S40). More specifically, the action control section 43 may permit the body ECU 9 to lock or unlock the door lock device 6 in the case where the area determination section 42 has determined that the position of the terminal 2 is the outside R1 of the vehicle cabin. For another example, the action control section 43 may permit the transition operation of the vehicle power supply via the ignition switch 50 in the vehicle cabin in the case where the area determination section 42 has determined that the position of the terminal 2 is the inside R2 of the vehicle cabin.

### 1.5. Effects

According to the above-described embodiment, the single communication device 31 is disposed at the position where it is difficult to directly receive the radio waves communicated between the outside R1 of the vehicle cabin and the inside R2 of the vehicle cabin. Therefore, a large ranging value is obtained on the basis of propagation time of the radio waves communicated between the communication device 31 and the terminal 2 present in the outside R1 of the vehicle cabin. This makes it possible to reduce the possibility that a ranging value based on propagation time of radio waves transmitted/received between the communication device 31 and the terminal 2 present in the outside R1 of the vehicle cabin is equal to a ranging value based on propagation time of radio waves transmitted/received between the communication device 31 and the terminal 2 present in the inside R2 of the vehicle cabin. Therefore, according to the embodiment of the present invention, it is possible to determine the position of the terminal 2 with high accuracy while reducing cost (because the number of necessary communication devices is reduced to two).

More specifically, the first communication device 34 (an example of the communication device 31) is disposed at a first position where it is difficult to directly receive the radio waves between the inside of the vehicle cabin (an example of the first area) and the outside of the vehicle cabin (an example of the second area) that are separated by a first member including material through which it is difficult for the radio waves to penetrate. In addition, the second communication device 35 is disposed at a second position where it is possible to directly receive the radio waves between the inside of the vehicle cabin and the outside of the vehicle cabin.

In addition, the verification ECU 8 (an example of the control device) includes the area determination section 42 configured to determine the position of the terminal 2 on the basis of the first ranging result obtained from radio waves communicated between the first communication device 34 and the terminal 2 and the second ranging result obtained from radio waves communicated between the second communication device 35 and the terminal 2. Such a configuration makes it possible to determine the position of the terminal 2 with high accuracy.

### 1.6. Modifications

Although details of the preferable embodiments of the present invention have been described above with reference to the appended drawings, the present invention is not limited thereto. It will be clear to a person of ordinary skill in the art of the present invention that various modifications and improvements may be obtained within the scope of the technical idea recited by the scope of the appended claims, and it should be understood that they will naturally come under the technical scope of the present invention.

For example, it is possible to modify the embodiments of the present invention as described below. The above-described embodiments of the present invention and modifications of the present invention to be described below may be combined with each other to perform the present invention unless they are technologically contradictory to each other.

### Modification Related to Area

The above-described example has mainly focused on the case where the area determination section 42 determines whether the position of the terminal 2 is the outside R1 of the vehicle cabin or the inside R2 of the vehicle cabin on the basis of the ranging result of the distance between the first communication device 34 and the terminal 2 and the ranging result of the distance between the second communication device 35 and the terminal 2. However, the area determined as an area where the terminal 2 is present is not limited to the outside R1 of the vehicle cabin and the inside R2 of the vehicle cabin. In other words, the area determination section 42 may determine whether the position of the terminal 2 is within the third area or the fourth area on the basis of the ranging result of the distance between the first communication device 34 and the terminal 2 and the ranging result of the distance between the second communication device 35 and the terminal 2.

For example, the area determination section 42 may determine whether the position of the terminal 2 is in an area (fourth area) located within a predetermined distance from the vehicle 1 or in an area (third area) located beyond the predetermined distance from the vehicle 1 on the basis of the ranging result of the distance between the first communication device 34 and the terminal 2 and the ranging result of the distance between the second communication device 35 and the terminal 2. It is considered that such a determination may be made by increasing the first threshold and the second threshold (more than the thresholds used in the case of determining whether the position of the terminal 2 is the outside R1 of the vehicle cabin or the inside R2 of the vehicle cabin). The first threshold is compared with the ranging value indicated by the ranging result of the distance between the first communication device 34 and the terminal 2, the second threshold is compared with the ranging value indicated by the ranging result of the distance between the second communication device 35 and the terminal 2, and the third threshold is compared with the representative value.

### Modification Related to Permission of Action

The above-described example has mainly focused on the case where the action control section 43 controls action of the vehicle 1 on the basis of the position of the terminal 2 determined by the area determination section 42. In particular, the above-described example has mainly focused on the case of permitting the doors of the vehicle 1 to be locked or unlocked if it is determined that the position of the terminal 2 is the outside R1 of the vehicle cabin, and the case of permitting the engine of the vehicle 1 to start if it is determined that the position of the terminal 2 is the inside R2 of the vehicle cabin. However, the target whose action is permitted is not limited thereto.

For example, technologies (remote parking technologies) that allow a user at a location away from the vehicle 1 to operate the terminal 2 to move and stop the vehicle 1 have been known. In the case of using the remote parking technology, the vehicle 1 accidentally collides with the user unless the vehicle 1 is permitted to move after a sufficient distance is kept between the user and the vehicle 1. Therefore, the action control section 43 may permit the vehicle 1 to move in the case where the area determination section 42 has determined that the position of the terminal 2 is in an area located beyond a predetermined distance from the vehicle 1 (an example of the third area).

More specifically, the vehicle 1 is provided with various kinds of actuators (parking actuator) for controlling behavior related to parking including behavior of starting the engine to behavior of stopping the engine on the basis of a remote operation signal transmitted from the terminal 2. In this case, the action control section 43 may permit the parking actuator to perform automatic steering control over a steering wheel, automatic driving control, or vehicle parking control on the basis of remote operation signals transmitted from the terminal 2 when it is determined that the position of the terminal 2 is in an area located beyond a predetermined distance from the vehicle 1.

### Modification Related to Ranging Communication

The above-described example has mainly focused on the case where a trigger to start ranging communication is transmission/reception of the LF radio wave and the UHF radio wave between the terminal 2 and the first communication device 34 and between the terminal 2 and the second communication device 35. However, the trigger to start the ranging communication is not limited thereto. For example, the trigger to start the ranging communication may be an operation performed on the door handle of the vehicle door, or may be an operation performed on the ignition switch 50.

The above example has mainly focused on the case where the ranging value is calculated by each of the ranging section 38 of the first communication device 34 and the ranging section 39 of the second communication device 35. In this case, the first communication device 34 and the second communication device 35 transmits respective ranging radio waves to the terminal 2. However, it is also possible for a structural element other than the first communication device 34 or the second communication device 35 to calculate the ranging value. For example, the terminal 2 may calculate the ranging value. In this case, the terminal 2 may transmit the respective ranging radio waves to the first communication device 34 and the second communication device 35.

The above example has mainly focused on the case where the ranging values are calculated on the basis of the propagation time of the radio waves between the first communication device 34 and the terminal 2 and between the second communication device 35 and the terminal 2. However, the method of calculating the ranging value is not limited thereto. For example, in the case where one of the first communication device 34, the second communication device 35, and the terminal 2 transmits a radio wave and another of the first communication device 34, the second communication device 35, and the terminal 2 receives the radio wave, the another may measure strength of the received radio wave (received signal strength indicator (RSSI)) and may calculate a ranging value on the basis of the strength of the received radio wave.

In addition, the radio wave may be transmitted by using a plurality of channels. In this case, each of the ranging section 38 and the ranging section 39 may calculate the ranging value on the basis of respective results of transmitting the radio waves by using the plurality of channels (propagation time or strength of received radio wave).

The method of the ranging communication (ranging radio wave and response radio wave) is not limited to the method of using the UWB radio waves. For example, a radio wave of another frequency may be used for the ranging communication. As an example, Bluetooth (registered trademark) communication may be used for the ranging communication.

### Various Modifications of System

The above examples have mainly focused on the case where the wake signal is transmitted from the vehicle 1 to the terminal 2. However, the wake signal may be transmitted from the terminal 2 to the vehicle 1.

The above examples have mainly focused on the case where the terminal 2 is the electronic key. However, the terminal 2 is not limited to the electronic key. For example, the terminal 2 may be an intelligent cell phone capable of wirelessly communicating with the vehicle 1.

The communication methods and the frequencies of the radio waves used for various kinds of communication between the vehicle 1 and the terminal 2 may be modified into various embodiments. In addition, the above examples have mainly focused on the case where a communication partner of the terminal 2 is the vehicle 1. However, the communication partner of the terminal 2 is not limited to the vehicle 1. It is possible to change the communication partner to various machines or devices.

Reference Signs List
1 vehicle
2 terminal
6 door lock device
7 engine
8 verification ECU
20 terminal control section
30 distance measurement system
32 response process section
34 first communication device
35 second communication device
38 ranging section
39 ranging section
42 area determination section
43 action control section
50 ignition switch
161 frame part
162 glass window part

1. A control device that communicates with a first communication device and a second communication device, the control device comprising:
a determination section configured to determine a position of a terminal on a basis of a first ranging result obtained from a radio wave communicated between the first communication device and the terminal and a second ranging result obtained from a radio wave communicated between the second communication device and the terminal,
wherein the first communication device is disposed at a first position where it is difficult to directly receive the radio wave between a first area and a second area that are separated by a first member including material through which it is difficult for the radio wave to penetrate, and
the second communication device is disposed at a second position where it is possible to directly receive the radio wave between the first area and the second area.

2. The control device according to claim 1,
wherein the determination section determines whether the position of the terminal is within a third area or a fourth area on a basis of the first ranging result and the second ranging result.

3. The control device according to claim 2,
wherein the determination section determines whether the position of the terminal is within the fourth area or the third area on a basis of whether or not a condition that a ranging value indicated by the first ranging result is smaller than a first threshold and a condition that a ranging value indicated by the second ranging result is smaller than a second threshold are satisfied.

4. The control device according to claim 2, comprising
an action control section configured to control action of a predetermined machine or device on a basis of the position of the terminal.

5. The control device according to claim 4,
wherein the action control section controls action of a mobile object as the predetermined machine or device.

6. The control device according to claim 5,
wherein the action control section permits a door of the mobile object to be locked or unlocked in a case where it is determined that the position of the terminal is within the third area.

7. The control device according to claim 5,
wherein the action control section permits an engine of the mobile object to start in a case where it is determined that the position of the terminal is within the fourth area.

8. The control device according to claim 5,
wherein the action control section permits the mobile object to move in a case where it is determined that the position of the terminal is within the third area.

9. The control device according to claim 1, wherein
the first ranging result is a ranging result indicating a minimum ranging value among a plurality of ranging results obtained from radio waves communicated between the first communication device and the terminal, and
the second ranging result is a ranging result indicating a minimum ranging value among a plurality of ranging results obtained from radio waves communicated between the second communication device and the terminal.

10. The control device according to claim 1,
wherein the first position is a position in the second area, the position being shielded from the first area by the first member.

11. The control device according to claim 1,
wherein the material through which it is difficult for the radio wave to penetrate is metal.

12. The control device according to claim 1,
wherein the second position is a position in the second area, the position being shielded from the first area by a second member including material that allows the radio wave to penetrate through more easily than the material included in the frame member.

13. The control device according to claim 12,
wherein the material that allows the radio wave to penetrate through easily is glass.

14. A non-transitory computer readable medium having a program stored therein, the program that causes a computer to function as
a control device configured to communicate with a first communication device and a second communication device, the control device including:
a determination section configured to determine a position of a terminal on a basis of a first ranging result obtained from a radio wave communicated between the first communication device and the terminal and a second ranging result obtained from a radio wave communicated between the second communication device and the terminal,
wherein the first communication device is disposed at a first position where it is difficult to directly receive the radio wave between a first area and a second area that are separated by a first member including material through which it is difficult for the radio wave to penetrate, and
the second communication device is disposed at a second position where it is possible to directly receive the radio wave between the first area and the second area.

15. A communication system comprising:
a first communication device configured to be disposed at a first position where it is difficult to directly receive a radio wave between a first area and a second area that are separated by a first member including material through which it is difficult for the radio wave to penetrate,
a second communication device configured to be disposed at a second position where it is possible to directly receive a radio wave between the first area and the second area, and
a control device including a determination section configured to determine a position of a terminal on a basis of a first ranging result obtained from a radio wave communicated between the first communication device and the terminal and a second ranging result obtained from a radio wave communicated between the second communication device and the terminal.
